(19) United States
(12) Patent Application Publication
(10) Pub. No.: US 2011/0079556 A1
(43) Pub. Date: Apr. 7, 2011

(54) SEPARATION OF SOLIDS FROM LIQUIDS BY FILTRATION AND CENTRIFUGATION

(76) Inventors: Lea Anderson-Smith, Marlboro, NJ (US); Andrew Beck, Somerset, NJ (US)

(21) Appl. No.: 12/571,504

(22) Filed: Oct. 1, 2009

(51) Int. Cl. B01D 43/00; B01D 11/02; B01D 15/00

(52) U.S. Cl. 210/633; 210/780; 210/781; 210/455

(57) ABSTRACT

A method and apparatus for efficiently performing solid phase extraction techniques for cleanup of samples to be used in analysis for pesticides, food products, etc. An insert to a centrifuge tube is disclosed which provides for mixing the solid and liquid, after which centrifuging is used to separate the liquid from the solid, after processing it through an appropriate filter.

### TECHNICAL FIELD

This invention relates to sample analysis, and more particularly, to an improved method and apparatus for preparation of samples for use in various analytical testing methods.

### BACKGROUND OF THE INVENTION

Solid phase extraction (SPE) is an extraction method that uses a solid phase and a liquid phase to isolate one or more components (i.e.; analytes) from a solution. It is usually used to clean up a sample before using a chromatographic or other analytical method to quantify the amount of analyte(s) in the sample. One procedure is to load a solution onto the SPE phase, wash away undesired components, and then wash off the desired analytes with another solvent into a collection tube. Another often use procedure is to pass the analytes through with the solvent and the undesirables remain on the SPE materials. In this case, a wash is not necessary. Present systems and methods for solid phase extraction typically use a disposable cartridge or similar device, and fall into one of three categories as explained below

Dispersive SPE: This technique uses loose clean-up solids in a centrifuge tube. Solution to be treated is added to the tube and the tube is shaken to mix the contents. The tube is then centrifuged, solids are collected in the bottom of the tube, and the liquid phase is removed by syringe or pipette and transferred to a clean vial.

SPE Cartridge: This technique uses a syringe barrel that is packed with clean-up solids. The solids are first wetted with the appropriate solvent. Then the solution to be treated is introduced into the cartridge and forced through the cartridge with positive pressure on top of the sample, or drawn through the column using negative pressure from below.

DPX-Qg Clean-up Pipette: In this method, a pipette containing dispersive clean-up solids is used. The solids are trapped between a filter at the pipette tip and another filter near the top of the pipette barrel. The solution to be treated is drawn up into the pipette using a bulb or automated system and is mixed with the solid materials by repeatedly expelling the liquid out of the pipette tip and refilling the pipette. (Offered by a company known as DPX Labs)

Each of the foregoing techniques however, has its own specific drawbacks.

With Dispersive SPE, after the centrifuge step, the liquid remains atop the undesired solids in a centrifuge tube. It can be difficult to extract the liquid from the solids without disturbing the solids in the bottom of the centrifuge tube. Disturbing the solids actually contaminates the liquid.

With SPE cartridges, additional solvent is required to pre-wet the solids and to wash them after use to ensure that all the analyte is removed. DPX-Qg requires several passes in and out of the pipette; if done by hand this is labor intensive. Hence, these latter two techniques are somewhat more costly than desirable.

In view of the foregoing, there exists a need in the art for a more efficient manner in which to perform SPE and related sample preparation techniques.

### BRIEF DESCRIPTION OF THE DRAWINGS

FIG. 1 is a side view of an exemplary embodiment of the present invention;

FIG. 2 depicts an exploded view of a specified portion of the embodiment of FIG. 1;

FIG. 3 shows an alternative embodiment of the present invention;

FIG. 4 depicts an exploded view of a portion of the embodiment of FIG. 3;

FIG. 4A shows a close-up view of a dividing portion of the embodiment of FIG. 4;

FIG. 5 shows an assembly diagram of a first embodiment of the present invention;

FIG. 6 shows an assembly diagram of a second embodiment of the present invention;

FIG. 7 is a more detailed diagram of certain portions of one exemplary embodiment of the invention; and

FIG. 8 shows the structure associated a series of channels used in one or more embodiments of the invention.

### DETAILED DESCRIPTION OF THE PREFERRED EMBODIMENT

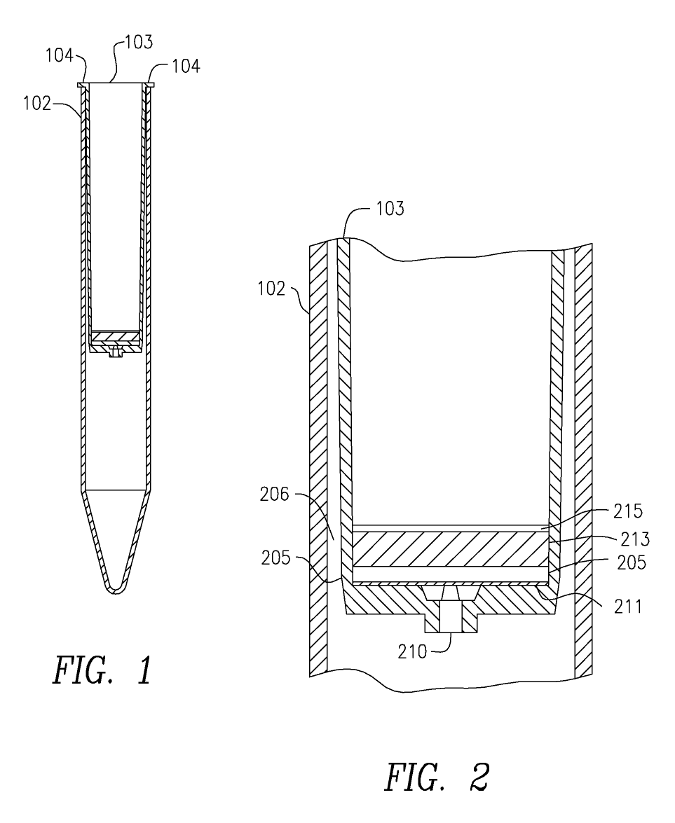

FIG. 1 depicts an exemplary embodiment of the present invention showing a centrifuge tube 102 with an insert 103 contained therein. The bottom portion of the insert 103 is shown in exploded view in FIG. 2, with like parts being designated with the same numerals for purposes of explanation. As indicated in FIG. 1, an insert 103 comprising ledges 104 is inserted into a centrifuge tube 102. Optionally, a snap or friction fit may be provided to maintain the insert 103 in the centrifuge tube 102.

In the exemplary embodiment shown in FIGS. 1 and 2, the side walls of the insert are tapered so as to form a friction fit towards the top of the centrifuge tube 102 but not at the bottom of the insert, where a small gap 206 as shown remains between the centrifuge tube 102 and the insert 103. Consequently, the insert may be easily slid into centrifuge tube 102, while still forming a relatively tight friction fit between centrifuge tube 102 and insert 103.

Turning to the more detailed view of an exemplary embodiment of the invention shown at FIG. 2, the bottom of insert 103 includes an opening 210, preferably disclosed at the center as shown. A thin layer of filter material 211 sits on the inside bottom surface of the insert 103 as depicted in FIG. 2. The filter material may be a membrane or fitted filter with pore size small enough to prevent solids from passing through during centrifugation. Examples of the filter material include, but are not limited to polyethylene, polypropylene, nylon, polytetrafluroethylene (Teflon®) or cellulose)

A felt or readily compressible pillow 205 is fitted with an insert 103 atop the filter material 211. Finally, a retainer 213, which preferably is in the form of a circular ring described later herein, is put in place to hold everything in the insert as shown. In one embodiment, a narrowed portion 215 forms a protuberance around the inner wall of the insert 103 so that the retainer may be snapped fit in place by pushing it from the top past the protuberance 215.

In operation, the appropriate amount of SPE solids are loaded into the insert 103 and the solution to be treated is then introduced into the insert 103. The tube is capped and shaken either by hand or automatic mechanical process.

Following the shaking step, the tube is centrifuged, forcing the liquid solution out of the bottom of the insert 103 and into centrifuge tube 102. The insert 103 may then simply be removed and the liquid left in the bottom of centrifuge tube 102.

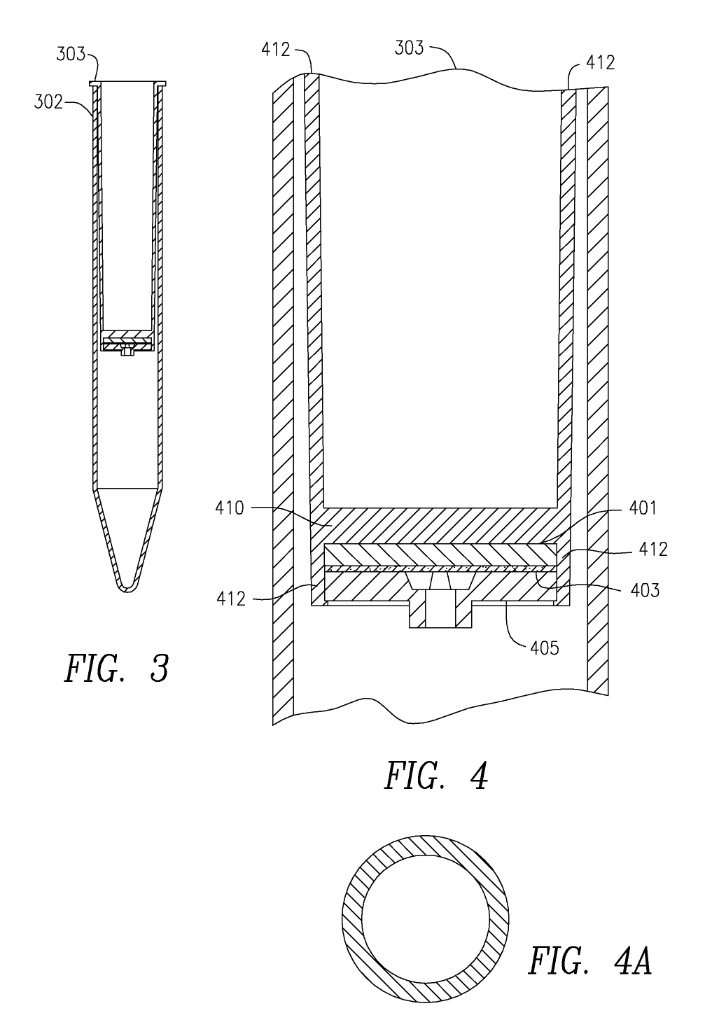

FIG. 3 shows an alternative embodiment of the present invention including an insert 303 inside a centrifuge tube 102. In the alternative of FIGS. 3 and 4, the insert does not have the same type of bottom as shown in FIG. 2. More specifically, a dividing portion 410 is utilized where the side walls 412 extend beyond and below said bottom portion as shown. The pillow 401 is installed underneath the dividing portion, with the filter material 403 underneath and a retainer 405 snapped in from below as shown to maintain the entire system in place. The dividing portion includes an opening in the middle as shown in FIG. 4A, in order to allow fluid to flow through during centrifuging.

In accordance with this additional embodiment of FIG. 4, the pillow 401, filter 403 and retainer 405 are fit from below the dividing portion 410, which also serves as the bottom of the section of insert 303 that holds the solution. Optionally, the portion of the walls 412 into which the retainer and other items are fit may also include a protuberance so that the retainer 405 can be snapped fit in place.

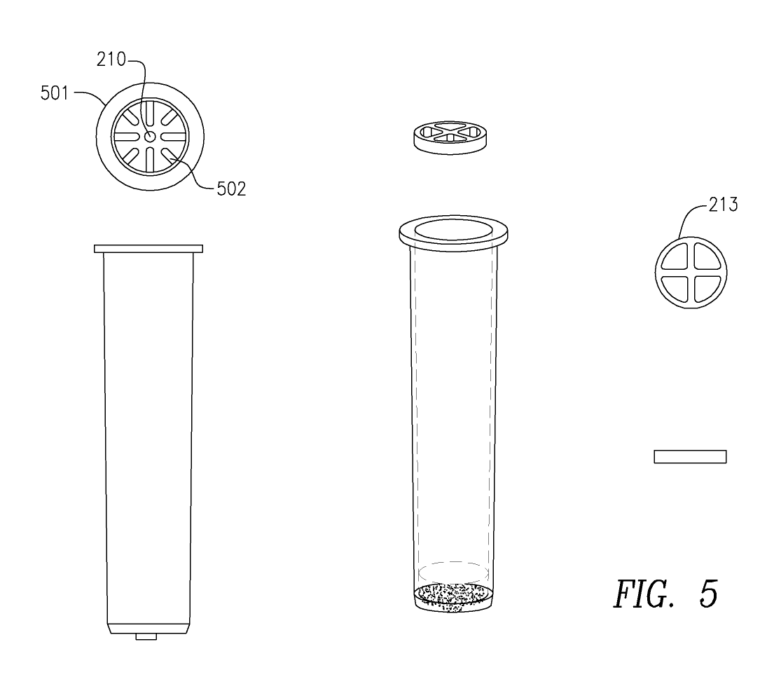

FIG. 5 depicts an assembly diagram of the present invention, showing a more detailed view of the retainer 213 and the inner bottom 501 of the insert 103 of FIG. 1.

As depicted in 501, a series of protuberances 502, preferably in the form of radial extending ribs, surround a central opening 210 in the inside surface of the bottom of insert 103.

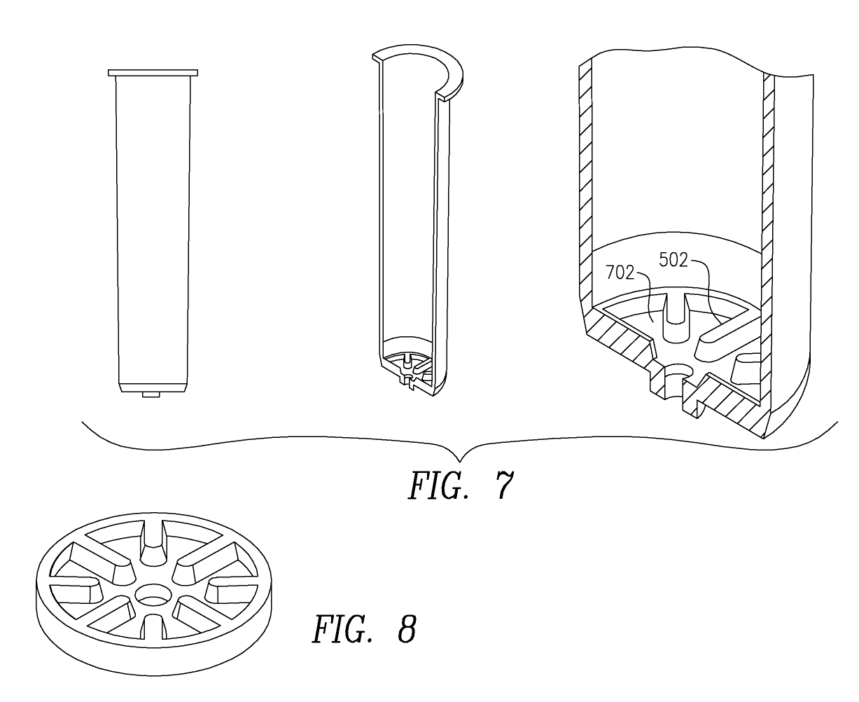

Referring FIG. 7, it can be seen that the series of protuberances 502 create channels 702 which may optimally be slanted toward the opening in the center so that fluid is forced towards the center during centrifuging.

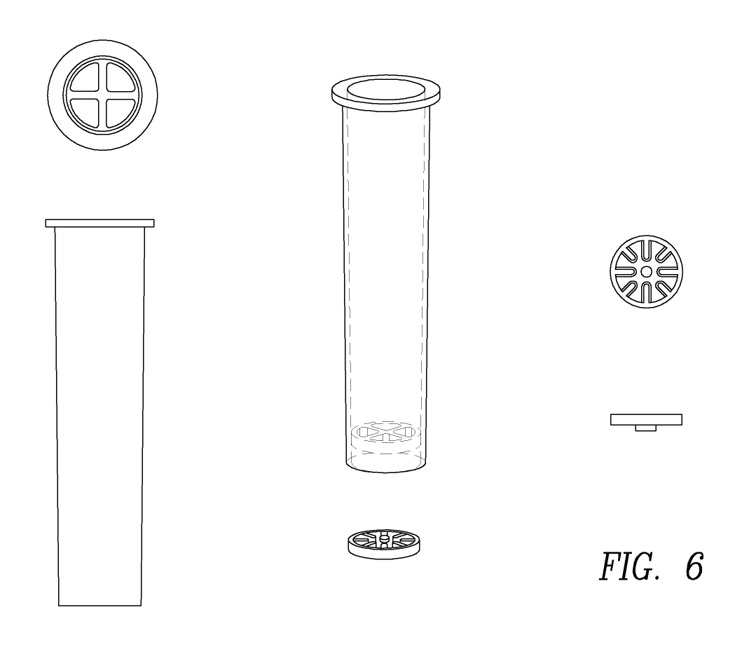

It is noted that in the embodiment indicated in FIGS. 3 and 4, the exemplary geometry of the bottom of insert 303 and the retainer are reversed. More specifically, as can be appreciated from FIGS. 104, the channels and protuberances should preferably be formed on the retainer, since it is inserted from the bottom of the insert 303. The geometry of the bottom of the insert 103 shown in FIG. 5 is replaced in FIG. 6 with that of the retainer as shown.

In accordance with the foregoing method and apparatus, an SPE or similar analog preparation method may be utilized by simply mixing liquid and solid in the insert, shaking it, and then centrifuging it, after which the insert may be removed and the prepared liquid ready for testing remains in the bottom of the centrifuge tube as shown.

While the foregoing describes the preferred embodiment of the invention, various other modifications or additions will be apparent to those skilled in the art. Such modifications are intended to be covered by the following claims appended hereto.

1. A method comprising placing an inner vessel within an outer vessel, said inner vessel having at least one opening allowing fluid flow between said inner vessel and said outer vessel, adding solid material and liquid material to said inner vessel, shaking said inner and outer vessels simultaneously, and forcing said fluid out of said inner vessel and into said outer vessel.

2. The method of claim 1 wherein the placing includes placing an inner vessel having filter therewithin, said filter held in place by a pillow and a retainer.

3. The method of claim 1 further comprising centrifuging the outer vessel with said inner vessel within said outer vessel to force said fluid out of said inner vessel and into said outer vessel.

4. Apparatus comprising an inner vessel having an inner bottom surface, said inner bottom surface including an exit canal, an outer vessel in which said inner vessel is removably maintained, and processing apparatus, said processing apparatus comprising a filter disposed against said inner bottom service, said filter being pressed against said inner bottom surface by a pillow, said pillow being held in place by a retainer.

5. Apparatus of claim 4 wherein said inner tube includes sidewalls and the retainer is snap fit into said inner tube by a protuberance along sidewalls of said inner tube.

6. The apparatus of claim 4 wherein said bottom surface includes an opening and a plurality of protrusions, said protrusions extending upwardly and forming channels that guide fluid towards the opening.

7. The apparatus of claim 6 wherein the protrusions substantially surround said opening.

8. Apparatus comprising an inner and outer vessel, said inner vessel having an outer wall extending around a dividing portion, said dividing portion being substantially perpendicular to said outer wall, said dividing portion having a large volume portion one a first side thereof, and a smaller volume portion on a second side thereof, said smaller volume portion including therewithin a pillow, a filter, and a retainer.

9. The apparatus of claim 8 wherein the pillow contacts said dividing portion and wherein said filter and said retainer do not contact said dividing portion.

10. The apparatus of claim 9 wherein said retainer includes a plurality of protrusions.

11. The apparatus of claim 10 wherein said protrusions comprise radially extending ribs, and wherein said radially extending ribs surround a central opening and funnel fluid towards said central opening.

12. A method of preparing a sample comprising introducing a solid phase extraction (SPE) material into an inner vessel, introducing a fluid into the inner vessel, shaking said inner vessel, centrifuging said inner vessel, and then removing the inner vessel from an outer vessel.

13. The method of claim 12 wherein said inner vessel comprises a dividing portion.

14. The method of claim 13 wherein the inner vessel has a bottom and the dividing portion is the bottom.

15. The method of claim 14 further comprising positioning a filter against the inside of the bottom of the inner vessel.

16. Apparatus comprising an inner tube and an outer tube, the inner tube having a bottom with an opening, a filter and pillow combination being disposed against the bottom and supported by a plurality of protrusions that separate the bottom portion from the filter and pillow combination.

17. The apparatus of claim 16 wherein the filter and pillow combination is disposed outside the inner tube and inside the outer tube.

18. The apparatus of claim 16 wherein the filter and pillow combination is separated from the bottom of the inner tube by a plurality of protrusions.

19. The apparatus of claim 18 wherein the protrusions are formed on the inner tube.

20. The apparatus of claim 18 wherein the protrusions are formed on a retainer installed inside the inner tube.
